(19) United States
(12) Patent Application Publication
(10) Pub. No.: US 2019/0264616 A1
(43) Pub. Date: Aug. 29, 2019

(54) DIRT COLLECTOR FOR GAS TURBINE ENGINE

(71) Applicant: United Technologies Corporation, Farmington, CT (US)

(72) Inventor: Jeffery A. Lovett, Tolland, CT (US)

(21) Appl. No.: 15/907,450

(22) Filed: Feb. 28, 2018

(51) Int. Cl. F02C 7/30; F01D 9/04; F23R 3/04; F04D 29/54

(52) U.S. Cl. CPC F02C 7/30; F01D 9/041; F02C 3/04; F04D 29/542; F23R 3/04

(57) ABSTRACT

A diffuser for a gas turbine engine includes an annular fluid passage that fluidly connects a diffuser inlet to a diffuser outlet. A plurality of airfoils are located in the annular fluid passage and each has a collection surface.

### BACKGROUND

A gas turbine engine typically includes a fan section, a compressor section, a combustor section, and a turbine section. Air entering the compressor section is compressed and delivered into the combustion section where it is mixed with fuel and ignited to generate a high-temperature and pressure gas flow. The hot gas flow expands through the turbine section to drive the compressor and the fan section.

During operation of a gas turbine engine in harsh environments, it is possible for the engine to ingest debris, such as sand and dirt, into the core flow path through the gas turbine engine. Although some of the debris may travel all the way through the engine and be exhausted out of the engine, a portion of the debris may adhere to surfaces within the gas turbine engine which can disrupt and block cooling holes and passages. The combustor section is particularly susceptible to this contamination because of the high temperatures of the combustor hardware and the typical use of many small cooling holes to direct cooling air and provide thermal protection. Therefore, there is a need to reduce the amount of dirt and sand which reaches the combustor of the gas turbine engine.

### SUMMARY

In one exemplary embodiment, a diffuser for a gas turbine engine includes an annular fluid passage that fluidly connects a diffuser inlet to a diffuser outlet. A plurality of airfoils are located in the annular fluid passage and each has a collection surface.

In a further embodiment of any of the above, the plurality of airfoils extend in a circumferential direction through the annular fluid passage.

In a further embodiment of any of the above, the plurality of airfoils are supported by struts that extend in a radial direction through the annular fluid passage and the struts include a strut collection surface.

In a further embodiment of any of the above, a leading edge of each of the airfoils includes at least one of a resistive heat strip or a bleed air passage.

In a further embodiment of any of the above, a cross-sectional area of the plurality of airfoils is greater than 50% of the cross-sectional area of the annular fluid passage.

In a further embodiment of any of the above, the annular fluid passage includes a high velocity region that has a cross-sectional area that is axially upstream of a diffusion region that has a larger cross-sectional area than the high velocity region. The plurality of airfoils are located in the high velocity region.

In a further embodiment of any of the above, a leading edge of each of the plurality of airfoils includes a recess defined by a pair of leading edge protrusions.

In a further embodiment of any of the above, the plurality of airfoils are removable from the diffuser.

In a further embodiment of any of the above, a leading edge of each of the plurality of airfoils includes a surface adhesion treatment.

In another exemplary embodiment, a gas turbine engine includes a compressor section which includes a downstream most rotor. A combustor section is located axially downstream of the compressor section. A diffuser is located axially downstream from the downstream most rotor and axially upstream of the combustor section. The diffuser includes an annular fluid passage that fluidly connects a diffuser inlet to a diffuser outlet. A plurality of airfoils is located in the annular fluid passage and each has a collection surface. At least one fluid splitter is located axially upstream and spaced from the plurality of airfoils.

In a further embodiment of any of the above, the plurality of airfoils extend in a circumferential direction through the annular fluid passage and are supported by struts that extend in a radial direction through the annular fluid passage.

In a further embodiment of any of the above, a cross-sectional area of the plurality of airfoils is greater than or equal to 50% of a cross-sectional area of the annular fluid passage.

In a further embodiment of any of the above, the annular fluid passage includes a high velocity region that has a cross-sectional area that is axially upstream of a diffusion region that has a larger cross-sectional area than the high velocity region. The plurality of airfoils are located in the high velocity region.

In a further embodiment of any of the above, the plurality of airfoils include an upstream portion that has a greater thickness than a trailing edge. There are a greater number of the plurality of airfoils than at least one splitter.

In a further embodiment of any of the above, a leading edge of each of the plurality of airfoils includes a recess defined by a pair of leading edge protrusions. The recess extends in one of a radial or circumferential direction.

In another exemplary embodiment, a method of collecting debris entering a gas turbine engine includes locating a plurality of airfoils in an annular fluid passage of a diffuser. The diffuser is located axially between a compressor section and a combustor section. Debris is collected traveling through the diffuser on a leading edge of the plurality of airfoils by changing a direction of flow of fluid traveling over the plurality of airfoils.

In a further embodiment of any of the above, the annular fluid passage includes a high velocity region that has a cross-sectional area that is axially upstream of a diffusion region that has a larger cross-sectional area than the high velocity region. The plurality of airfoils are located in the high velocity region.

In a further embodiment of any of the above, the method includes heating the plurality of airfoils to promote debris to collect on the leading edge.

In a further embodiment of any of the above, a cross-sectional area of the plurality of airfoils is greater than or equal to 50% of a cross-sectional area of the annular fluid passage. The plurality of airfoils include an upstream portion that has a greater thickness than a trailing edge.

In a further embodiment of any of the above, the method includes manipulating a flow of air entering the diffuser with at least one splitter located axially forward and spaced from the plurality of airfoils. There are a greater number of the plurality of airfoils than at least one splitter.

### BRIEF DESCRIPTION OF THE DRAWINGS

FIG. 1 is a schematic view of an example gas turbine engine according to a first non-limiting example.

FIG. 2 is a partial enlarged view of a compressor exit section and a combustor section illustrating a plurality of collection airfoils in an example configuration.

FIG. 3 is an enlarged view of an airfoil illustrating a plurality of collection airfoils in another example configuration.

FIG. 4 illustrates a cross-sectional view of one of the plurality of collection airfoils.

### DETAILED DESCRIPTION

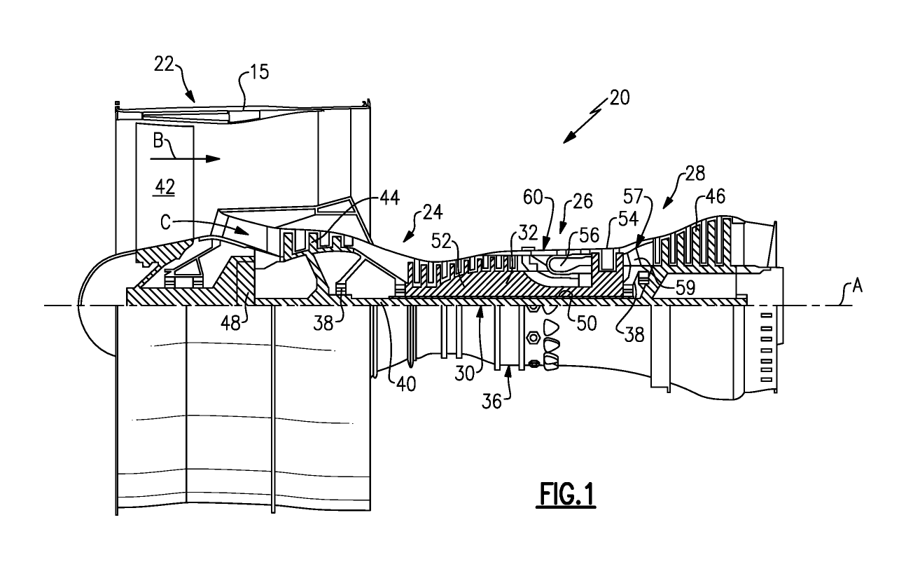

FIG. 1 schematically illustrates a gas turbine engine 20. The gas turbine engine 20 is disclosed herein as a two-spool turbofan that generally incorporates a fan section 22, a compressor section 24, a diffuser 60, a combustor section 26 and a turbine section 28. The fan section 22 drives air along a bypass flow path B in a bypass duct defined within a nacelle 15, and also drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A diffuser 60 is used to transfer the high velocity air stream from the compressor 52 to the combustor 26 by slowing and diffusing the air stream down to a lower velocity before entering the combustor 26. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, diffused to lower velocity in the diffuser 60, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram °R)/(518.7°R)]^{0.5}. The “Low corrected fan tip speed” as disclosed herein according to one non-limiting embodiment is less than about 1150 ft/second (350.5 meters/second).

FIG. 2 illustrates an enlarged schematic view of a portion of the compressor section 24 and a portion of the combustor section 26 showing the diffuser 60. As air traveling through the core flow path C is compressed in the compressor section 24, it enters an annular fluid passage 62 of the diffuser 60 at high velocities where it is manipulated to expand to lower velocities in an expanding flowpath 70 before the air reaches the combustor 56. The annular fluid passage 62 is defined by an inner ring 63 and an outer ring 65. In the illustrated example, only a downstream most rotor stage 64 in the high pressure compressor 52 is shown, however, the high pressure compressor 52 includes multiple stages as shown in FIG. 1.

The diffuser 60 includes an inlet 66 to the annular fluid passage 62 having an annular inlet cross-sectional area and an outlet 67 of the annular fluid passage 62 having an annular outlet cross-sectional area that is much larger than the annular inlet cross-sectional area thereby reducing the air stream velocity. Additionally, immediately downstream of the inlet 66, the annular fluid passage 62 contains multiple radial struts 72 in the flowpath needed to mechanically connect the inner ring 63 and outer ring 65. The flow blockage due to these struts further increases the air stream velocity in the diffuser annular section between the inlet 66 and a following annular section 68. The annular section 68 following the struts 72 has a cross-sectional area that is either identical to the annular inlet cross-sectional area or within 10% of the annular inlet cross-sectional area so the air stream remains at a high velocity. The annular section 68 transitions into the expanding flowpath 70 where the cross-sectional area increases from the cross-sectional area of the high velocity region 68 to the larger annular outlet cross-sectional area of the outlet 67 thereby decreasing the air stream velocity before reaching the combustor section 56.

When the air from the core flow path C enters the diffuser 60, the struts 72 typically turn the air to correct for a rotational direction imparted on the air as a result of compression by the rotors in the compressor section 24. The struts 72 are located immediately downstream from the inlet 66 of the annular fluid passage 62 in the high velocity region 68. Since the air velocity in annular fluid passage 62 of the diffuser 60 is very high, it presents the opportunity to collect the dirt or sand existing in the air stream since adhesion is enhanced by high velocities. A plurality of collection airfoils 74 are located immediately downstream and spaced from the struts 72 such that the plurality of collection airfoils 74 are axially separated from the struts 72. The plurality of collection airfoils 74 are also located in the high velocity region 68. However, it is possible that a portion of a trailing edge 76 of one of the plurality of collection airfoils 74 extends into the expanding flowpath 70 of the annular fluid passage 62. The collection airfoils 74 collect a significant portion of the sand and dirt in the core stream preventing the debris from entering the combustor 56. The collection airfoils 74 can either remain in place, or in another embodiment, they can be removed from the engine to allow cleaning of the airfoils and re-insertion into the diffuser 60 as a maintenance capability. The collection airfoils 74 could also be integrated with the mechanical support struts 72.

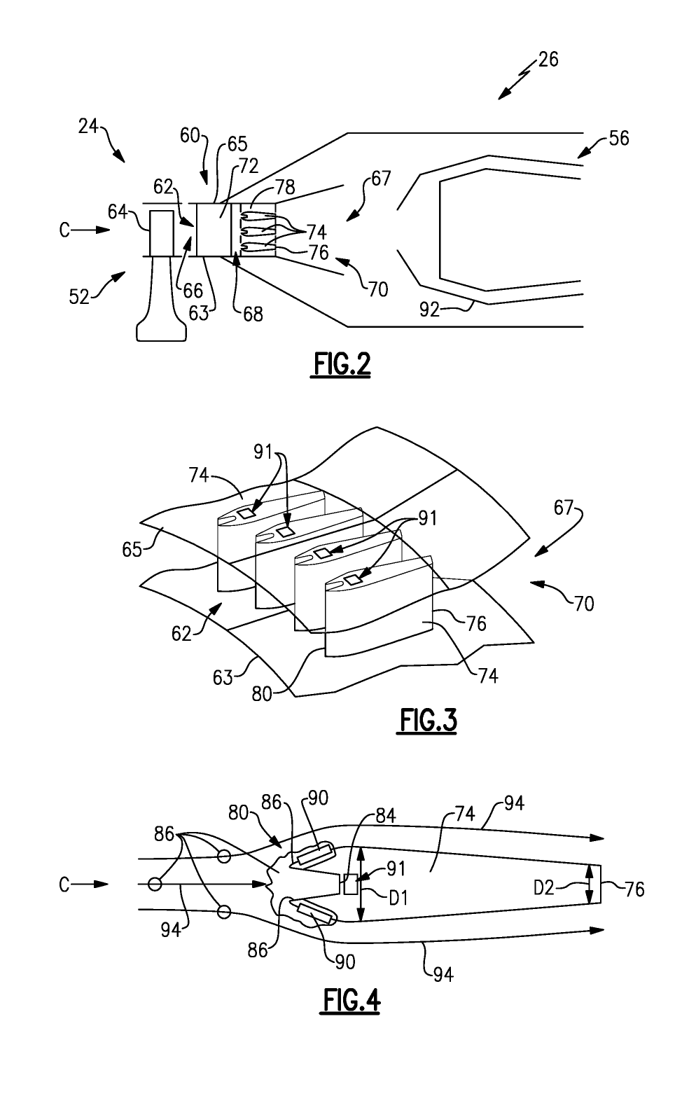

In the illustrated non-limiting example shown in FIG. 2, the plurality of collection airfoils 74 extend in a circumferential direction through the annular fluid passage 62. The plurality of collection airfoils 74 are supported in the annular fluid passage 62 by multiple struts 78 extending in a radial direction such that the plurality of collection airfoils 74 form circumferential segments defined by the struts 78. In the illustrated non-limiting example shown in FIG. 3, each of the plurality of collection airfoils 74 extend in a radial direction between the radially inner ring 63 and the radially outer ring 65 of the diffuser 60.

In one example, the plurality of collection airfoils 74 include a cross-sectional area that is equal to or greater than 25% of a cross-sectional area of the annular fluid passage 62 to increase the air stream velocity and increase debris impact and adhesion. In another example, the plurality of collection airfoils 74 include a cross-sectional area that is equal to or greater than 50% of a cross-sectional area of the annular fluid passage 62 to further increase the air stream velocity. The collection airfoils 74 are aerodynamically shaped to include an airfoil type cross section to end with a thin trailing edge 76 to smoothly diffuse the air stream and minimize pressure losses created by the collection airfoils 74.

As shown in FIG. 4, which is a cross-sectional view of one of the plurality of collection airfoils 74, each of the collection airfoils 74 includes an airfoil type cross section. In the illustrated example, a portion of collection airfoil 74 near a leading edge 80 includes a thickness D1 that is greater than a thickness D2 of the collection airfoil 74 at or near a trailing edge 76. The plurality of collection airfoils 74 may also include a symmetric profile about a plane extending in a longitudinal direction.

The leading edge 80 of each of the plurality of collection airfoils 74 may include a recess 84 defined by a pair of leading edge protrusions 86 to increase the debris collection capacity of the collection airfoil 74. In the example of FIG. 2 where the plurality of collection airfoils 74 extend in a circumferential direction, the recess 84 would also extend in a circumferential direction. Similarly, in the example of FIG. 3 wherein the plurality of collection airfoils 74 extend in a radial direction, the recess 84 would also extend in a radial direction. In this disclosure, axial or axially, circumferential or circumferentially, and radial or radially is in relation to the engine axis A unless stated otherwise.

Additionally, it is possible that the leading edge of the plurality of collection airfoils does not have the recess 84, which contributes to collection of debris 86 traveling through the diffuser 60, but instead includes a surface treatment 88, such as a surface texture or special material coating to encourage the collection of debris 86. Special materials that include catalytic chemical reactions or particle charge attraction could be used to enhance collection of debris at the leading edge. In another example, the surface treatment 88 is applied in the area of the recess 84.

Also, in addition to or in place of the surface treatment 88, the plurality of collection airfoils 74 could be heated, such as by at least one resistive heat strip 90 integrated into the leading edge 80 or through the use of bleed air in a bleed air passage 91. A heated surface will increase the collection effectiveness of the leading edge 80 of the collection airfoils 74. Additionally, the strut 78 could include the same treatment along a leading edge as the plurality of collection airfoils 74.

As shown in FIG. 4, when the air traveling through the core flow path C approaches one of the collection airfoils 74, a direction of flow of the core flow path C changes. When the core flow path C includes debris 86, the change in direction of the core flow path C along flow lines 94 results in the debris 86 resisting that change indirection because of momentum and the debris 86 comes into contact with the collection airfoil 74. When the debris 86 contacts the collection airfoil 74, the debris 86 will adhere to the collection airfoil 74 due to the high temperature of the collection airfoil 74 and/or because of the force of impact. As more debris 86 collects on the collection airfoil 74, the buildup of debris 86 will bind with more debris 86. By reducing the amount of debris 86 that passes through the diffuser 60, less debris 86 will reach the combustor 56 where the debris 86 can plug cooling holes 92 in a surface of the combustor 56.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A diffuser for a gas turbine engine comprising:
an annular fluid passage fluidly connecting a diffuser inlet to a diffuser outlet; and
a plurality of airfoils located in the annular fluid passage and each having a collection surface.

2. The diffuser of claim 1, wherein the plurality of airfoils extend in a circumferential direction through the annular fluid passage.

3. The diffuser of claim 2, wherein the plurality of airfoils are supported by struts extending in a radial direction through the annular fluid passage and the struts include a strut collection surface.

4. The diffuser of claim 1, wherein a leading edge of each of the airfoils includes at least one of a resistive heat strip or a bleed air passage.

5. The diffuser of claim 1, wherein a cross-sectional area of the plurality of airfoils is greater than 50% of the cross-sectional area of the annular fluid passage.

6. The diffuser of claim 1, wherein the annular fluid passage includes a high velocity region having a cross-sectional area that is axially upstream of a diffusion region having a larger cross-sectional area than the high velocity region and the plurality of airfoils are located in the high velocity region.

7. The diffuser of claim 1, wherein a leading edge of each of the plurality of airfoils includes a recess defined by a pair of leading edge protrusions.

8. The diffuser of claim 1, wherein the plurality of airfoils are removable from the diffuser.

9. The diffuser of claim 1, wherein a leading edge of each of the plurality of airfoils includes a surface adhesion treatment.

10. A gas turbine engine comprising:
a compressor section including a downstream most rotor;
a combustor section located axially downstream of the compressor section;
a diffuser located axially downstream from the downstream most rotor and axially upstream of the combustor section, the diffuser including:
an annular fluid passage fluidly connecting a diffuser inlet to a diffuser outlet;
a plurality of airfoils located in the annular fluid passage and each having a collection surface; and
at least one fluid splitter located axially upstream and spaced from the plurality of airfoils.

11. The gas turbine engine of claim 10, wherein the plurality of airfoils extend in a circumferential direction through the annular fluid passage and are supported by struts extending in a radial direction through the annular fluid passage.

12. The gas turbine engine of claim 10, wherein a cross-sectional area of the plurality of airfoils is greater than or equal to 50% of a cross-sectional area of the annular fluid passage.

13. The gas turbine engine of claim 10, wherein the annular fluid passage includes a high velocity region having a cross-sectional area that is axially upstream of a diffusion region having a larger cross-sectional area than the high velocity region and the plurality of airfoils are located in the high velocity region.

14. The gas turbine engine of claim 10, wherein the plurality of airfoils include an upstream portion having a greater thickness than a trailing edge and there are a greater number of the plurality of airfoils than the at least one splitter.

15. The gas turbine engine of claim 10, wherein a leading edge of each of the plurality of airfoils includes a recess defined by a pair of leading edge protrusions and the recess extends in one of a radial or circumferential direction.

16. A method of collecting debris entering a gas turbine engine comprising:
locating a plurality of airfoils in an annular fluid passage of a diffuser, wherein the diffuser is located axially between a compressor section and a combustor section; and
collecting debris traveling through the diffuser on a leading edge of the plurality of airfoils by changing a direction of flow of fluid traveling over the plurality of airfoils.

17. The method of claim 16, wherein the annular fluid passage includes a high velocity region having a cross-sectional area that is axially upstream of a diffusion region having a larger cross-sectional area than the high velocity region and the plurality of airfoils are located in the high velocity region.

18. The method of claim 17, further comprising heating the plurality of airfoils to promote debris to collect on the leading edge.

19. The method of claim 16, wherein a cross-sectional area of the plurality of airfoils is greater than or equal to 50% of a cross-sectional area of the annular fluid passage and the plurality of airfoils include an upstream portion having a greater thickness than a trailing edge.

20. The method of claim 16, further comprising manipulating a flow of air entering the diffuser with at least one splitter located axially forward and spaced from the plurality of airfoils and there are a greater number of the plurality of airfoils than the at least one splitter.
